(19) United States
(12) Patent Application Publication
(10) Pub. No.: US 2008/0235335 A1
(43) Pub. Date: Sep. 25, 2008

(54) METHOD, SYSTEM, AND COMPUTER PROGRAM PRODUCT FOR CHANGING THE STATUS OF AN EXISTING EMAIL IN A RECIPIENT EMAIL CLIENT INBOX

(75) Inventors: Gregory R. Hintermeister, Rochester, MN (US); Michael D. Rahn, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/688,465

(22) Filed: Mar. 20, 2007

(51) Int. Cl. G06F 15/16

(52) U.S. Cl. 709/206

(57) ABSTRACT

A method, system, and computer program product for changing the status of an existing email in a recipient email client inbox are provided. The method includes receiving a message from an email server that includes a message identifier identifying the existing email message, the existing email message transmitted to the recipient email client inbox. The method also includes retrieving the existing email message corresponding to the message identifier, replacing a date and time of the existing email message with a current date and time corresponding to a time the message is transmitted, and moving the existing email message to the top of an email queue of the recipient email client inbox. The method further includes marking the existing email message at the top of the email queue as unread and notating the existing email message with the date and time of the existing email message.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to messaging applications, and particularly to a method, system, and computer program product for changing the status of an existing email in a recipient email client inbox.

2. Description of Background

Before our invention, sending email client users would need to retransmit a previously sent email or compose an entirely new email (e.g., by way of a reminder) when a recipient of the email has been unresponsive. In doing so, the recipient's email storage (and the sender's sent folder storage) may be significantly increased, particularly when attachments are included in the email. In addition, tracking activity with respect to a delivered email can be cumbersome where multiple recipients have been addressed in the email. For example, where ten individuals are addressed in an email, it may be time-consuming and inefficient to follow up to determine which, if any, of the recipients have taken requested action on the email or whether one or more recipients have ignored the message. If this instance, the sender needs to duplicate the email or resend the original email in order to determine the status. Similar tracking issues arise when adding new recipients to a forwarded email.

What is needed, therefore, is a way to handle email message transmissions so that all parties to the transmissions are provided with up-to-date message information without undue burden on email system storage requirements.

### SUMMARY OF THE INVENTION

The shortcomings of the prior art are overcome and additional advantages are provided through the provision of a method, system, and computer program product for changing the status of an existing email message in a recipient email client inbox. The method includes receiving a message from an email server that includes a message identifier identifying the existing email message, the existing email message transmitted to the recipient email client inbox from the sender email client. The method also includes retrieving the existing email message corresponding to the message identifier, replacing a date and time of the existing email with a current date and time corresponding to a time the message is transmitted by the sender email client, and moving the existing email message to the top of an email queue of the recipient email client inbox. The method further includes marking the existing email message at the top of the email queue as unread and notating the existing email message at the top of the email queue with the date and time of the existing email message.

Systems and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which enables a user at an email client system to modify and update an existing email message that was previously transmitted to a recipient email client from the user without retransmitting any portion of the existing email, thereby reducing storage requirements of both the user's and the recipient's email system, while providing up-to-date messaging information.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which message handling activities may be implemented in an exemplary embodiment;

FIG. 2 illustrates one example of a flow diagram describing a process for implementing messaging handling activities in an exemplary embodiment;

FIG. 3A illustrates one example of a computer screen window prior to implementing the message handling activities; and

FIG. 3B illustrates one example of a computer screen window subsequent to implementing the message handling activities.

The detailed description explains the preferred embodiments of the invention, together with advantages and features, by way of example with reference to the drawings.

### DETAILED DESCRIPTION OF THE INVENTION

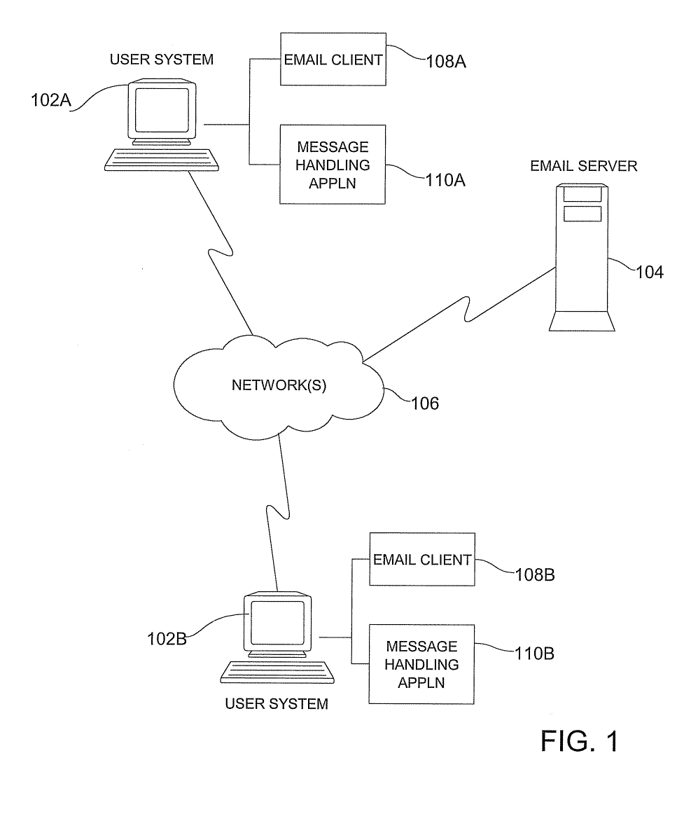

Turning now to the drawings in greater detail, it will be seen that in FIG. 1 there is a system upon which messaging handling activities may be implemented in accordance with an exemplary embodiment.

The system of FIG. 1 includes user systems 102A-102B in communication with one another via one or more email servers, such as email server 104, and one or more networks 106.

Each user system 102A, 102B may be implemented using a general-purpose computer executing a computer program for carrying out the processes described herein. The user systems 102A-102B may be personal computers (e.g., a lap top, a personal digital assistant, etc.) or host attached terminals. If the user systems 102A-102B are personal computers, the processing described herein may be shared by a user system 102A, 102B and a host system (not shown) (e.g., by providing an applet to the user system 102A, 102B) where network 106 includes e.g., a local area network (LAN).

The user systems 102A-102B implement email clients 108A-108B, respectively. The email clients may include any type of communications applications including, e.g., electronic mail (email), instant messaging (IM), chat room applications, etc. In exemplary embodiments, the user systems 102A-102B execute a message handling application 110A-110B, respectively, for implementing the messaging handling functions described herein. While the email clients 108A and 108B are shown as separate applications from respective message handling applications 110A and 110B, it will be understood that the applications 108A-108B and 110A-110B may be integrated as a single messaging tool for performing both email messaging functions and the message handling functions described herein.

The networks 106 may include any type of known networks including, but not limited to, a wide area network (WAN), a local area network (LAN), a global network (e.g. Internet), a virtual private network (VPN), and an intranet. The networks 106 may be implemented using a wireless network or any kind of physical network implementation known in the art. A user system 102A, 102B may be coupled to one another through multiple networks (e.g., intranet and Internet) so that not all user systems 102A, 102B are in communication through the same network. One or more of the user systems 102A, 102B may be connected to the networks 106 in a wireless fashion.

In exemplary embodiments, user systems 102A and 102B each include a storage system component, e.g., internal memory of the user systems 102A-102B. The storage system component stores, e.g., data, images, video, audio, etc. In exemplary embodiments, the storage system component stores email messages received at respective user systems 102A and 102B. The email messages may be stored in a queue with a date/timestamp associated with each email message using, e.g., a first-in-first-out (FIFO) system. The email messages are accessible by the respective email client applications 108A and 108B and presented to the recipient user of the user system 102A/102B. The storage system component may be implemented using a variety of devices for storing electronic information. Information stored in the storage system component may be retrieved and manipulated via the respective user systems 102A-102B.

Email messages are transmitted between email client applications 108A-108B via one or more email servers, such as email server 104. Email server 104 may be an SMTP, POP3, IMAP, or similar type of server system that provides email messaging services over one or more networks 106. Email server 104 may also provide calendaring, tasking, and various other services.

As indicated above, the message handling activities of the exemplary embodiments handle email message transmissions so that all parties to the transmissions are provided with up-to-date message information without undue burden on email system storage requirements. The message handling application 110, in cooperation with the email client application 108, provides several messaging handling services, including “re-prime,” “message handled,” “suggest handler,” “keep in loop,” and “teamroom” options as will be described further herein.

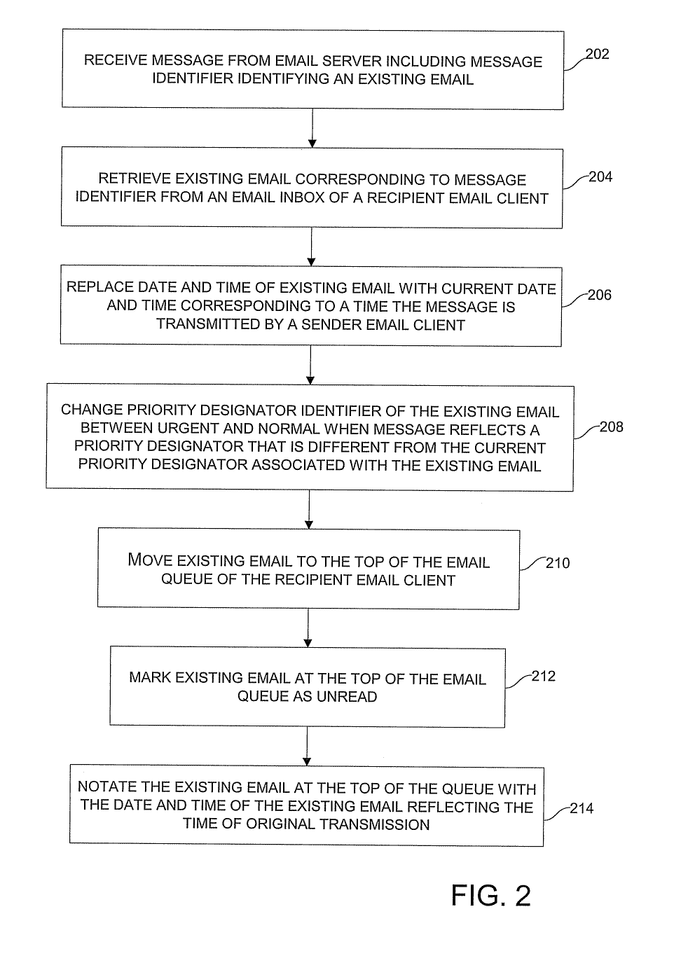

Turning now to FIG. 2, a flow diagram describing a process for providing message handling activities will now be described in accordance with exemplary embodiments. For purposes of illustration, user system 102A of FIG. 1 will be described as a sender email system (where, e.g., email client application 108A is referred to as a sender email client) and user system 102B will be described as a recipient email system (where, e.g., email client application 108B is referred to as a recipient email client). The process described in FIG. 2 assumes that an original email message (also referred to herein as existing email message) has been transmitted to, and received at, the recipient email client 108B. The original email message may be stored in a message queue in memory at the user system 102B. The process described in FIG. 2 further assumes that the sender of the original email message (e.g., a user at user system 102A) has not received a response to the original email message and has selected an option of the message handling application 110A to “re-prime” the existing email message. The term re-prime, as used herein, refers to a process by which an existing email message in a recipient's inbox is modified to include current information desired by the sender of the email message. The “re-prime” option may be presented to the sender within the email application 108A and may be implemented, e.g., as an icon in the ‘sent email’ folder (not shown). By selecting the desired email message and the “re-prime” option, the message handling application 110A transmits a corresponding message to the email server 104 that identifies the existing email message and a corresponding action (e.g., “re-prime”) to be taken on the existing email message with respect to the recipient email inbox folder (e.g., via email client 108B and message handling application 110B).

At step 202, a message (e.g., the “re-prime” message) is received at the recipient email client 102B from email server 104. The message includes a message identifier that identifies the existing email message to be re-primed, e.g., by a timestamp of original transmission of the existing email message and an email address of the sender email client 108A. At step 204, the message handling application 110B at the recipient user system 102B retrieves the existing email message corresponding to the message identifier from an email inbox of the recipient email client 108B.

At step 206, the message handling application 110B replaces the date and time of the existing email message (e.g., the date and time of original transmission or the most recent re-prime action if the existing message has been re-primed subsequent to the original email message transmission) with a current date and time corresponding to the time the message (e.g., re-prime message) is transmitted by the sender email client 102A. At step 208, a priority designator (e.g., urgent, normal, etc.) of the existing email is changed (e.g., between urgent and normal) when the message (e.g., re-prime message) reflects a priority designator that is different from the current existing priority designator associated with the existing email message.

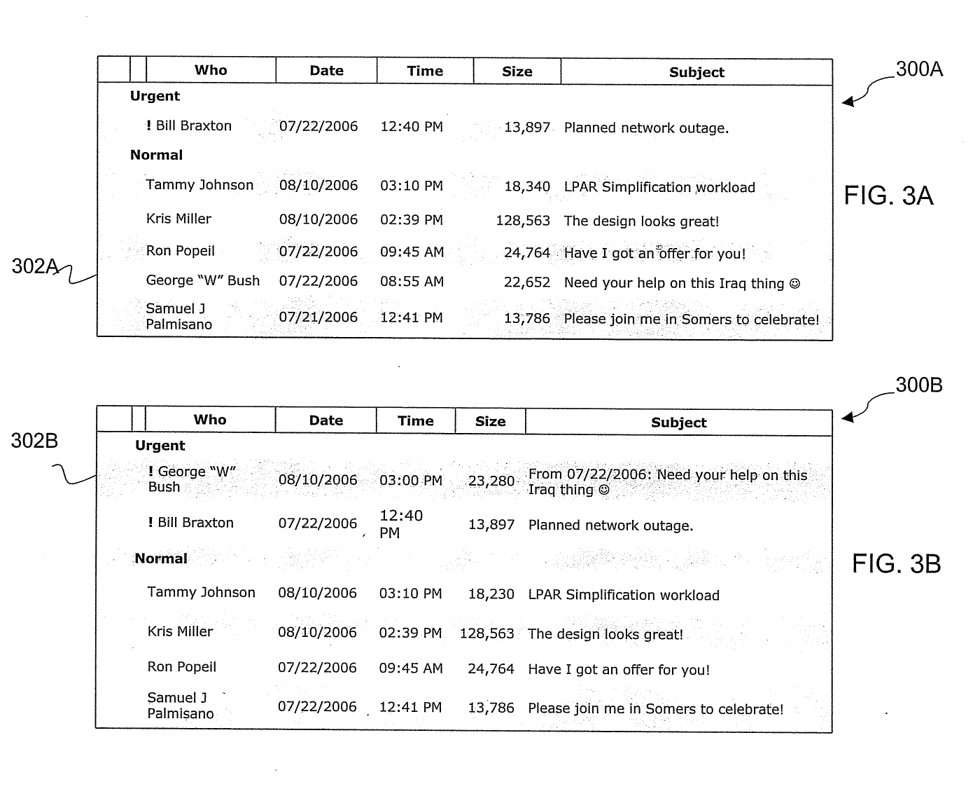

At step 210, the existing email is moved to the top of an email queue of the recipient email client 108B and the existing email message is marked as “unread” at step 212. At step 214, the existing email at the top of the email queue is notated with the date and time of the existing email (or the most recent re-prime action if the existing message has been re-primed subsequent to the original email message transmission). The notation reflects the date and time of the existing email and is presented, e.g., in the subject line portion, whereas the updated date and time is reflected, e.g., in the “received column” of the email client inbox as shown in FIG. 3B.

FIG. 3A illustrates a computer screen window for an email client application (e.g., recipient email client 108B) before a user of the sending user system 102A implements the “re-prime” function. In particular, FIG. 3A illustrates an email inbox folder of the recipient user system 102B. FIG. 3B illustrates a computer screen window for the email client application after the “re-prime” function has been implemented. In particular, FIG. 3B illustrates an email inbox folder of the recipient user system 102B subsequent to implementation of the re-prime option. As shown in computer screen window 300A FIG. 3A, a message 302 in a recipient's email inbox has an original date/timestamp of Jul. 22, 2006, and reflects an original priority designator of “normal.” A sender at user system 102A selects the corresponding message in the sent folder of the sender's email client application 108A followed by the “re-prime” option and priority designator change. The process described in FIG. 2 is performed and the results thereof are shown in computer screen window 300B of FIG. 3B. As shown in FIG. 3B, the existing email message 302A is moved to the top of the recipient's email queue and modified to include a current date/timestamp with a priority designator of “urgent” (message 302B).

The message handling application 110 includes a messaging handling identifier for providing additional options to the user. The message handling identifier is transmitted with the message (e.g., re-prime message) to the email server 104. The options include a “message handled” option, a “suggest handler” option, a “keep in loop” option, and a “teamroom” option. These options may be presented to a user via an icon located in an interface of the email application 108A-108B (e.g., within the email client inbox at a time the user initiates an option to compose a new email message). When a user, e.g., selects the “message handled” option, a recipient of the existing email message may view a list of email recipients who have received, viewed, forwarded, responded, and/or deleted the existing email message. When a user selects the “suggest handler” option, a recipient is identified from a list of email recipients as being one who is selected to respond or take action on the existing email message. In this maimer, other recipients in the list will understand their appropriate role, e.g., whether to take action on the email or view as information.

When the sender selects the “keep in loop” option, an email address of an entity, who is selected to be copied each time the existing email message or email thread of the existing email message is forwarded and responded to, is identified. Thus, when the existing email message is responded to or forwarded, the entity identified in the email address is notified and copied.

When the sender selects the “teamroom email” option, the existing email is stored in a central location accessible to a list of email recipient. As the recipients access the existing email, they are viewing the centrally stored email content. In this manner, the sender may update the existing email message stored in the central location without needing to retransmit the updated email to each of the recipients.

Among other advantages, the messaging handling functions reduce email storage requirements, provide a cleaner, less cluttered email inbox/sentbox, prevent multiple threads from occurring, and enable a sender to change the priority status of an existing email as needed without retransmitting the email message.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow.

What is claimed is:

1. A method for changing the status of an existing email message in a recipient email client inbox, comprising:
receiving a message from an email server, the message including a message identifier that identifies the existing email message by a timestamp of original transmission of the existing email message and an email address of a sender email client, the existing email message transmitted to the recipient email client from the sender email client;
retrieving the existing email message corresponding to the message identifier from the recipient email client inbox;
replacing a date and time of the existing email message with a current date and time corresponding to a time the message is transmitted by the sender email client;
changing a priority designator identifier of the existing email message between urgent and normal when the message reflects a priority designator that is different from a currently assigned priority designator associated with the existing email message;
moving the existing email message to the top of an email queue of the recipient email client inbox;
marking the existing email message at the top of the email queue as unread; and
notating the existing email message at the top of the email queue with the date and time of the existing email message, the date and time of the existing email message reflecting at least one of a time of original transmission and most recent email message update.

2. The method of claim 1, wherein the message further includes a message handling identifier comprising a message handled option, a suggest handler option, a keep in loop option, and a teamroom email option, the method further comprising:
viewing a list of email recipients who have received, viewed, forwarded, responded, and deleted the existing email message when the message handling identifier reflects selection of the message handled option by the sender email client;
identifying a recipient from a list of email recipients who is selected to respond or take action on the existing email message when the suggest handler option is selected;
identifying an email address of an entity who is selected to be copied each time the existing email message or email thread of the existing email message is forwarded and responded to when the keep in loop option is selected; and
storing the existing email message in a central location accessible to a list of email recipients when the teamroom email option is selected.

3. A system for changing the status of an existing email message in a recipient email client inbox, comprising:
a computer system executing an email client; and
a message handling application executing on the computer system and in communication with the email client, the message handling application implementing a method, comprising:
receiving a message from an email server, the message including a message identifier that identifies the existing email message by a timestamp of original transmission of the existing email message and an email address of a sender email client, the existing email message transmitted to the recipient email client inbox from the sender email client, the recipient email client inbox provided by the email client;
retrieving the existing email message corresponding to the message identifier from the recipient email client inbox;
replacing a date and time of the existing email message with a current date and time corresponding to a time the message is transmitted by the sender email client;
changing a priority designator identifier of the existing email message between urgent and normal when the message reflects a priority designator that is different from a currently assigned priority designator associated with the existing email message;
moving the existing email message to the top of an email queue of the recipient email client inbox;
marking the existing email message at the top of the email queue as unread; and
notating the existing email message at the top of the email queue with the date and time of the existing email message, the date and time of the existing email message reflecting at least one of a time of original transmission and most recent email message update.

4. The system of claim 3, wherein the message further includes a message handling identifier comprising a message handled option, a suggest handler option, a keep in loop option, and a teamroom email option, the method further comprising:
viewing a list of email recipients who have received, viewed, forwarded, responded, and deleted the existing email message when the message handling identifier reflects selection of the message handled option by the sender email client;
identifying a recipient from a list of email recipients who is selected to respond or take action on the existing email message when the suggest handler option is selected;
identifying an email address of an entity who is selected to be copied each time the existing email message or email thread of the existing email message is forwarded and responded to when the keep in loop option is selected; and
storing the existing email message in a central location accessible to a list of email recipients when the teamroom email option is selected.

5. A computer program product for changing the status of an existing email message in a recipient email client inbox, the computer program product including instructions for causing a computer to implement a method, comprising:
receiving a message from an email server, the message including a message identifier that identifies the existing email message by a timestamp of original transmission of the existing email message and an email address of a sender email client, the existing email message transmitted to the recipient email client from the sender email client;
retrieving the existing email message corresponding to the message identifier from the recipient email client inbox;
replacing a date and time of the existing email message with a current date and time corresponding to a time the message is transmitted by the sender email client;
changing a priority designator identifier of the existing email message between urgent and normal when the message reflects a priority designator that is different from a currently assigned priority designator associated with the existing email message;
moving the existing email message to the top of an email queue of the recipient email client inbox;
making the existing email message at the top of the email queue as unread; and
notating the existing email message at the top of the email queue with the date and time of the existing email message, the date and time of the existing email message reflecting at least one of a time of original transmission and most recent email message update.

6. The computer program product of claim 5, wherein the message further includes a message handling identifier comprising a message handled option, a suggest handler option, a keep in loop option, and a teamroom email option, the method further comprising:
viewing a list of email recipients who have received, viewed, forwarded, responded, and deleted the existing email message when the message handling identifier reflects selection of the message handled option by the sender email client;
identifying a recipient from a list of email recipients who is selected to respond or tale action on the existing email message when the suggest handler option is selected;
identifying an email address of an entity who is selected to be copied each time the existing email message or email thread of the existing email message is forwarded and responded to when the keep in loop option is selected; and
storing the existing email message in a central location accessible to a list of email recipients when the teamroom email option is selected.
